(19) United States
(12) Patent Application Publication
(10) Pub. No.: US 2022/0300676 A1
(43) Pub. Date: Sep. 22, 2022

(54) INFORMATION PROCESSING APPARATUS AND INFORMATION PROCESSING METHOD

(71) Applicant: Kioxia Corporation, Tokyo (JP)

(72) Inventors: Satoko HAYAMA, Fujisawa (JP); Ryota YOSHIZAWA, Yokohama (JP)

(73) Assignee: Kioxia Corporation, Tokyo (JP)

(21) Appl. No.: 17/350,506

(22) Filed: Jun. 17, 2021

(30) Foreign Application Priority Data
Mar. 18, 2021 (JP) 2021-044890

(51) Int. Cl. G06F 30/20; G06F 11/34

(52) U.S. Cl. CPC G06F 30/20; G06F 11/3457; G06F 2111/04

(57) ABSTRACT

An information processing apparatus has a constraint threshold value setting change unit configured to change a setting of a first constraint threshold value serving as a criterion when determining whether a constraint variable satisfies a constraint condition, and a search unit configured to search for the new constraint variable that satisfies the constraint condition based on the first constraint threshold value, wherein the constraint threshold value setting change unit is configured to update the first constraint threshold value based on the new constraint variable.

### CROSS REFERENCE TO RELATED APPLICATIONS

This application is based upon and claims the benefit of priority from the prior Japanese Patent Application No. 2021-044890, filed on Mar. 18, 2021, the entire contents of which are incorporated herein by reference.

### FIELD

An embodiment of the present invention relates to an information processing apparatus and an information processing method.

### BACKGROUND

Simulators are utilized for various purposes. It is necessary to adjust the value of the input parameter of the simulator in order to simulatively execute the operation of the complicated event in the simulator or obtain an ideal result in the simulation by the simulator.

In a case where an operation of a complicated event is simulatively executed by a simulator, a process of providing a constraint condition, intensively searching a range satisfying the constraint condition, and searching for an optimal solution is performed. However, in a case where the output data rapidly changes only when the input parameter has a certain value, it is not easy to accurately grasp the change, and there is a possibility that the deviation between the prediction result by the simulator and the actual event increases.

### BRIEF DESCRIPTION OF THE DRAWINGS

FIG. 1 is a block diagram illustrating a schematic configuration of a simulation system including an information processing apparatus according to the first embodiment;

FIG. 2 is a diagram of a first example illustrating a relationship between a target variable, a constraint variable, and a constraint threshold value;

FIG. 3 is a diagram illustrating an initial state of a prediction model of the target variable and a prediction model of the constraint variable in FIG. 2;

FIG. 4 is a diagram illustrating a prediction model of a target variable and a prediction model of a constraint variable after Bayesian optimization;

FIG. 5 is a diagram of a second example illustrating a relationship between a target variable, a constraint variable, and a constraint threshold value;

FIG. 6 is a diagram illustrating an initial state of a prediction model of the target variable and a prediction model of the constraint variable in FIG. 5;

FIG. 7 is a diagram illustrating a prediction model of a target variable and a prediction model of a constraint variable after Bayesian optimization;

FIG. 8 is a diagram schematically illustrating a procedure in which the prediction model of the target variable and the prediction model of the constraint variable corresponding to FIG. 5 are generated;

FIG. 9 is a diagram illustrating a procedure subsequent to FIG. 8;

FIG. 10 is a diagram for describing a procedure subsequent to FIG. 9;

FIG. 11 is a flowchart illustrating a processing operation of the simulation system according to the present embodiment;

FIG. 12 is a diagram comparing the processing result of optimization according to the present embodiment with that of Bayesian optimization of one comparative example;

FIG. 13 is a flowchart illustrating a processing operation of the simulation system according to the second embodiment; and

FIG. 14 is a diagram illustrating a correspondence relationship between a target variable and a constraint variable by plotting.

### DETAILED DESCRIPTION

According to one embodiment, an information processing apparatus has a constraint threshold value setting change unit configured to change a setting of a first constraint threshold value serving as a criterion when determining whether a constraint variable satisfies a constraint condition, and a search unit configured to search for the new constraint variable that satisfies the constraint condition based on the first constraint threshold value, wherein the constraint threshold value setting change unit is configure to update the first constraint threshold value based on the new constraint variable.

Hereinafter, embodiments of an information processing apparatus and an information processing method will be described with reference to the drawings. Although main components of the information processing apparatus and the information processing method will be mainly described below, the information processing apparatus and the information processing method may include components and functions that are not illustrated or described. The following description does not exclude components and functions that are not illustrated or described.

### First Embodiment

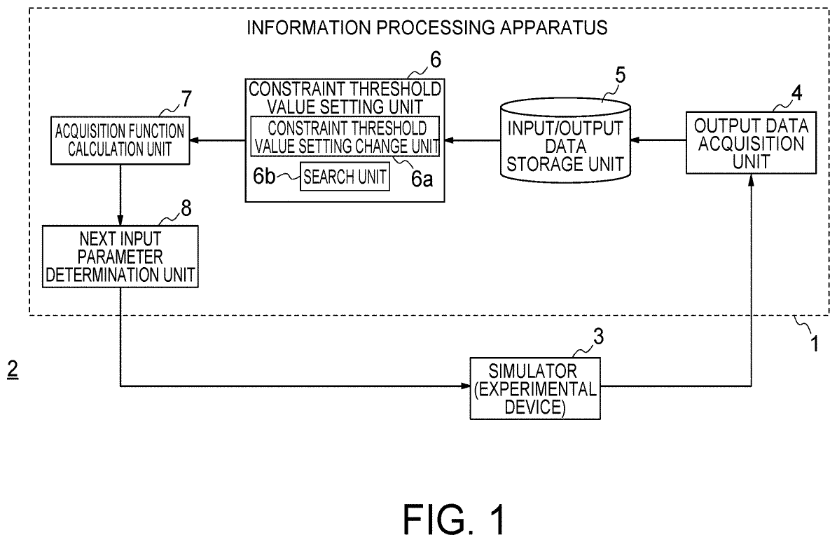

FIG. 1 is a block diagram showing a schematic configuration of a simulation system 2 including an information processing apparatus 1 according to the first embodiment. The simulation system 2 in FIG. 1 includes the information processing apparatus 1 and a simulator 3. The simulator 3 executes a simulation based on input parameters to output the output data indicating a simulation result. The information processing apparatus 1 optimizes the input parameters to be input to (set in) the simulator 3. Therefore, the information processing apparatus 1 in FIG. 1 can also be referred to as an optimization apparatus.

The simulation system 2 in FIG. 1 can include one or a plurality of computers. In this case, the computer executes a program for performing the processing operation of the information processing apparatus 1 and a program for performing the processing operation of the simulator 3. Alternatively, the processing operation of at least part of the information processing apparatus 1 and the simulator 3 may be executed by dedicated hardware (for example, a semiconductor device such as a signal processing processor or the like).

Note that the information processing apparatus 1 in FIG. 1 does not necessarily need to be connected to the simulator 3. For example, instead of the simulator 3, an experimental device that performs various experiments may be connected to the information processing apparatus 1 in FIG. 1. In this case, an experiment is performed by the experimental device using the input parameters optimized by the information processing apparatus 1 of FIG. 1. As described above, the information processing apparatus 1 in FIG. 1 is not necessarily built in the simulation system 2.

The information processing apparatus 1 in FIG. 1 includes an output data acquisition unit 4, an input/output data storage unit 5, a constraint threshold value setting unit 6, an acquisition function calculation unit 7, and a next input parameter determination unit 8.

The output data acquisition unit 4 acquires output data indicating the result of experiments or simulations based on input parameters of a predetermined number of dimensions. In the present specification, it is assumed that there is a plurality of input parameters used in an experiment or input to the simulator 3, and the number of input parameters (the number of items) is referred to as the number of dimension.

The output data acquisition unit 4 may acquire not only output data indicating a result of a simulation performed by the simulator 3 but also output data indicating an experimental result. Hereinafter, the process of acquiring output data from the simulator 3 and determining a next input parameter to the simulator 3 will be mainly described, but it is also possible to acquire output data from an experimental device instead of the simulator 3 and determine a next input parameter to the experimental device.

The output data acquired by the output data acquisition unit 4 includes a target variable and a constraint variable. The target variable is measurement result data by the simulator 3. The constraint variable is constrained data associated with the target variable. By comparing the constraint variable with the constraint threshold value, it is determined whether the constraint variable satisfies the constraint condition.

The input/output data storage unit 5 stores the input parameter and the corresponding output data as a set. The input parameter is, for example, a parameter representing a physical quantity such as temperature or pressure. The parameter representing a physical quantity is a concept including parameters related to experiments or simulations such as processing time and processing conditions. The number of items of the input parameters and the contents of the items are arbitrary. As described above, the output data includes the target variable and the constraint variable, and the input/output data storage unit 5 stores the input parameter, the target variable, and the constraint variable in association with each other.

The constraint threshold value setting unit 6 sets a provisional constraint threshold value serving as a criterion when determining a constraint condition of a constraint variable. The constraint threshold value setting unit 6 includes a constraint threshold value setting change unit 6a and a search unit 6b. The constraint threshold value setting change unit 6a changes the setting of the provisional constraint threshold value serving as a criterion when determining whether the constraint variable satisfies the constraint condition. In the present specification, the provisional constraint threshold value may be referred to as a first constraint threshold value. In addition, the first constraint threshold value set based on the measurement data may be referred to as a relative constraint threshold value.

The search unit 6b searches for a new constraint variable that satisfies the constraint condition based on the provisional constraint threshold value. The constraint threshold value setting change unit 6a updates the provisional constraint threshold value in consideration of the searched new constraint variable. In a more specific example, the search unit 6b searches for a new constraint variable that is located near the provisional constraint threshold value set by the constraint threshold value setting change unit 6a and that satisfies the constraint condition.

When the constraint variable includes a plurality of pieces of data, the constraint threshold value setting change unit 6a may set the relative constraint threshold value from among a plurality of pieces of data disposed in ascending or descending order. The relative constraint threshold value may be a predetermined percentile value selected from among a plurality of pieces of data disposed in ascending or descending order.

The relative constraint threshold value may be selected based on a plurality of statistical values (for example, the deviation value) corresponding to a plurality of pieces of data. The provisional constraint threshold value or the relative constraint threshold value is a value that defines a constraint condition that is looser than a preset absolute constraint threshold value.

In the case of solving the minimization problem, the provisional constraint threshold value or the relative constraint threshold value gradually approaches the absolute constraint threshold value while the process of the constraint threshold value setting change unit 6a and the search unit 6b is repeated. While the provisional constraint threshold value or the relative constraint threshold value dynamically changes while the process of the constraint threshold value setting change unit 6a and the search unit 6b is repeated, the absolute constraint threshold value is a fixed value set in advance, and the value is unchanged even when the process of the constraint threshold value setting change unit 6a and the search unit 6b is repeated.

In the present specification, the absolute constraint threshold value may be referred to as a second constraint threshold value.

The constraint threshold value setting change unit 6a may change the provisional constraint threshold value or the relative constraint threshold value based on whether the best value of at least one of the target variable and the constraint variable is updated while updating the provisional constraint threshold value or the relative constraint threshold value a predetermined number of times. For example, when a constraint variable closer to the absolute constraint threshold value is found, a p value of a p percentile value for determining the relative constraint threshold value may be made smaller to make the constraint condition of the constraint variable stricter. Conversely, in a case where a constraint variable closer to the absolute constraint threshold value is not found while the provisional constraint threshold value or the relative constraint threshold value is updated a predetermined number of times, the constraint condition of the constraint variable may be loosened by increasing the p value.

The acquisition function calculation unit 7 calculates an acquisition function based on the input parameters and the provisional constraint threshold value (relative constraint threshold value). In the case of solving the minimization problem, the target variable is minimized when the acquisition function is maximized. In addition, the acquisition function may be an index representing an expected improvement amount.

The next input parameter determination unit 8 determines the next input parameter so that the acquisition function is maximized. The next input parameter determined by the next input parameter determination unit 8 is input to, for example, the simulator 3, and a new simulation is executed.

The simulator 3 executes the simulation again using the next input parameter determined by the next input parameter determination unit 8. Alternatively, the next input parameter may be input to the experimental device to perform the experiment again.

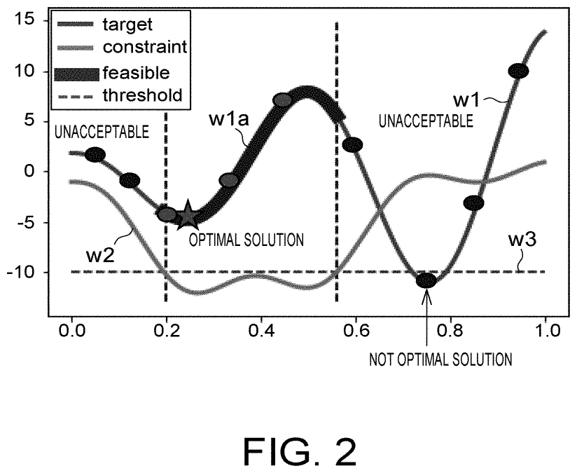

Before describing the optimization process performed by the information processing apparatus 1 and the simulation system 2 in FIG. 1, a constrained Bayesian optimization process as one comparative example will be described. FIG. 2 is a diagram of a first example illustrating a relationship between a target variable, a constraint variable, and a constraint threshold value. In FIG. 2, the horizontal axis represents the input parameter X, and the vertical axis represents the value of the target variable or the constraint variable. FIG. 2 illustrates a curve w1 representing the target variable, a curve w2 representing the constraint variable, and a straight line w3 representing the constraint threshold value. The target variable is measurement result data to be simulated. The constraint variable is constrained data associated with the target variable. For example, the constraint variable is the worst data of the measurement result data. The constraint threshold value is a value that determines whether the constraint variable satisfies the constraint condition, and for example, the constraint variable is required to be equal to or less than the constraint threshold value.

In the case of FIG. 2, the constraint variable is equal to or less than the constraint threshold value only in the range of the input parameter X=0.2 to 0.56. Therefore, the constraint variable satisfies the constraint condition only in the range of the input parameter X=0.2 to 0.56, and the optimum value is searched for from the target variable (thick line portion in FIG. 2) within this range. For example, in the case of solving the minimization problem, the target variable has the minimum value (=−5) when the input parameter X=0.25.

In the example of FIG. 2, the target variable has the minimum value (less than −10) near the input parameter X=about 0.75, but the constraint variable does not satisfy the constraint condition in the range of the input parameter X=0.56 or more, and thus the minimum value of the target variable is regarded as −5 as described above.

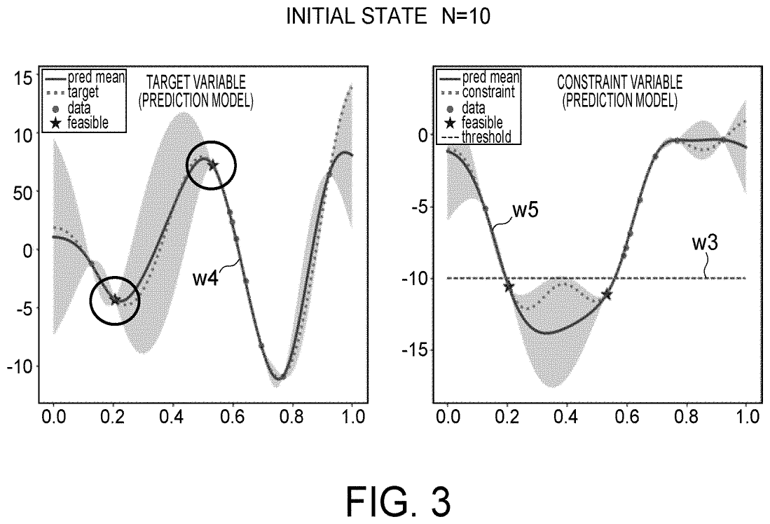

FIG. 3 is a diagram illustrating an initial state of the prediction model of the target variable and the prediction model of the constraint variable in FIG. 2. The left side illustrates a curve w4 of the prediction model of the target variable, and the right side illustrates a curve w5 of the prediction model of the constraint variable. In FIG. 3, the number of measurement points N is 10. In the case of the number of measurement points N=10, the curve shape of the curve w4 of the prediction model of the target variable cannot be determined, and blurring occurs in the curve shape as illustrated in gray color. In addition, unlike the curve w2 of FIG. 2, the change in the curve near the minimum value of the curve w5 of the prediction model of the constraint variable cannot be tracked.

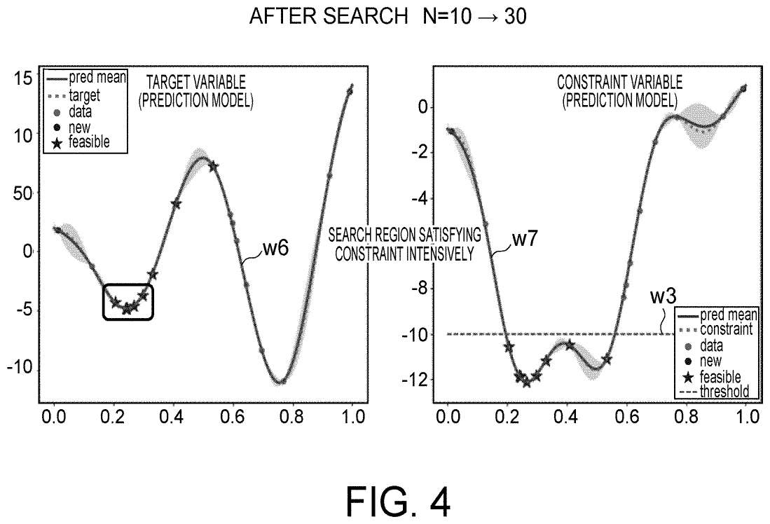

FIG. 4 is a diagram illustrating a prediction model of a target variable and a prediction model of a constraint variable after Bayesian optimization. In FIG. 4, the number of measurement points N is 30. FIG. 4 illustrates a curve w6 of the prediction model of the target variable and a curve w7 of the prediction model of the constraint variable. In the Bayesian optimization, an acquisition function is calculated from a prediction model of a target variable and a prediction model of a constraint variable, and a range in which the constraint variable satisfies a constraint condition is intensively searched. The newly increased number of measurement points is concentrated in this range, whereby the measurement is intensively performed within the range in which the constraint variable satisfies the constraint condition, and the shapes of the waveforms w6 and w7 in the vicinity where the target variable is minimized can be faithfully reproduced. The gray part in FIG. 4 indicates a blur due to an error of the prediction model.

As described above, in FIG. 4, by using the Bayesian optimization, the optimization process can be efficiently performed based of the range in which the constraint variable satisfies the constraint condition. However, the optimization process may not be appropriately performed even by the Bayesian optimization.

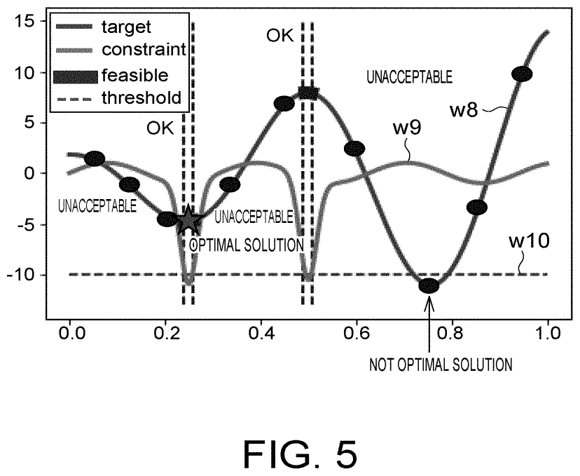

FIG. 5 is a diagram of a second example illustrating a relationship between a target variable, a constraint variable, and a constraint threshold value. FIG. 5 illustrates a curve w8 representing the target variable, a curve w9 representing the constraint variable, and a straight line w10 representing the constraint threshold value. The curve w8 of the target variable in FIG. 5 is similar to the curve w1 in FIG. 2, but the curve w9 of the constraint variable in FIG. 5 is greatly different from the curve w2 in FIG. 2. The constraint variable in FIG. 5 sharply drops locally (where the input parameter X is around 0.25 and around 0.5).

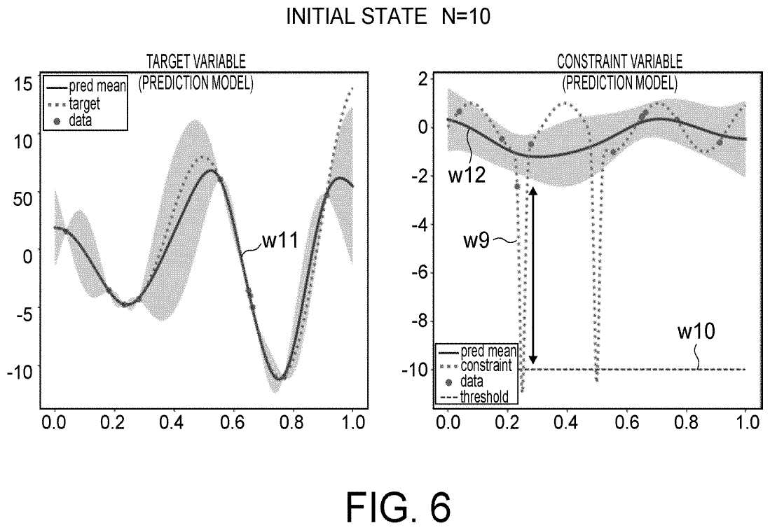

FIG. 6 is a diagram illustrating an initial state of the prediction model of the target variable and the prediction model of the constraint variable in FIG. 5. In FIG. 6, the number of measurement points N is 10. FIG. 6 illustrates a curve w11 of the prediction model of the target variable and a curve w12 of the prediction model of the constraint variable. In the case of the number of measurement points N=10, it is not possible to detect the tendency of the constraint variable that locally decreases sharply, and the curve w12 of the prediction model of the constraint variable has a waveform shape greatly different from that of the curve w9 in FIG. 5. The gray part in FIG. 6 indicates a blur due to an error of the prediction model.

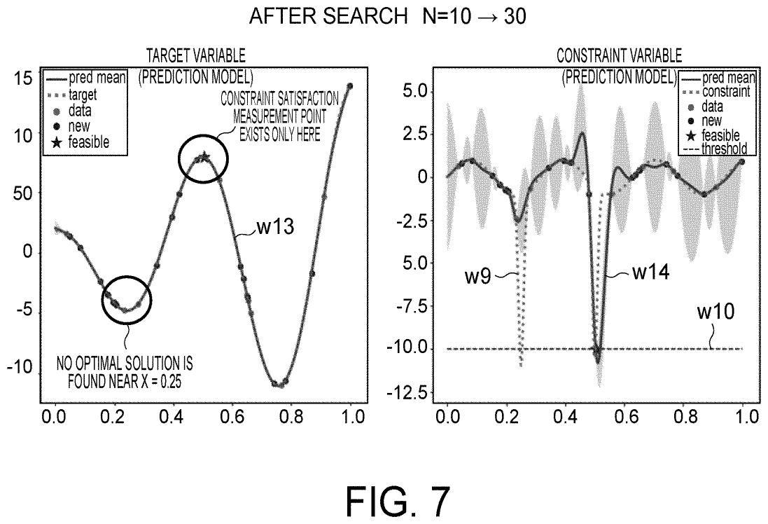

FIG. 7 is a diagram illustrating a prediction model of a target variable and a prediction model of a constraint variable after Bayesian optimization. In FIG. 7, the number of measurement points N is 30. FIG. 7 illustrates a curve w13 of the prediction model of the target variable and a curve w14 of the prediction model of the constraint variable. In FIG. 7, in a case where there is a measurement point by chance at a place where the constraint variable rapidly decreases due to the increase in the number of measurement points, the value of the measurement point can be reflected in the curve shape of the constraint variable. However, in a case where there is a plurality of places where the constraint variable rapidly changes, the curve shape of the constraint variable cannot be faithfully predicted. The gray part in FIG. 7 indicates a blur due to an error of the prediction model.

The information processing apparatus 1 according to the present embodiment is capable of faithfully and accurately generating a prediction model of a target variable and a prediction model of a constraint variable even with the constraint variable rapidly changing locally as illustrated in FIG. 5, thereby optimizing an input parameter.

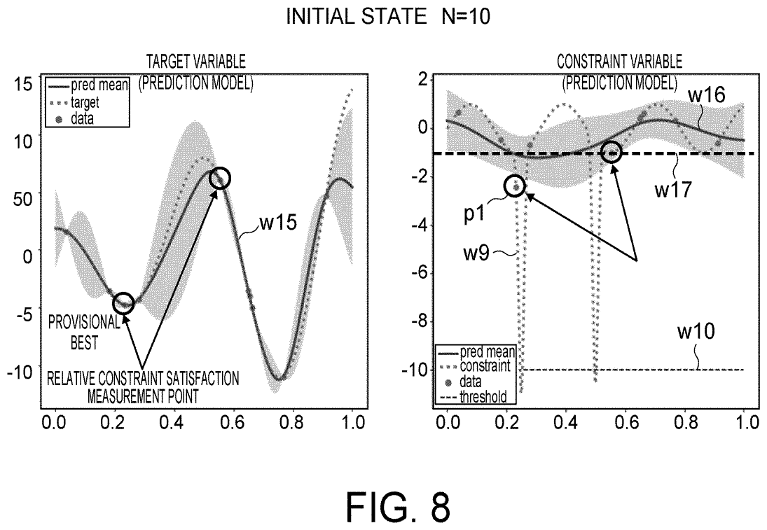

FIGS. 8 to 10 are diagrams schematically illustrating a procedure in which the prediction model of the target variable and the prediction model of the constraint variable corresponding to FIG. 5 are generated using the information processing apparatus 1 according to the present embodiment. Hereinafter, an example of solving the minimum value problem to search for the minimum value of the target variable will be described. Note that the gray part in FIGS. 8 to 10 indicate a blur due to an error of the prediction model.

In the present embodiment, as illustrated in FIG. 8, the process of setting and updating the relative constraint threshold value is repeated. The relative constraint threshold value is, for example, a p percentile value of the current constraint variable. The p percentile value is a value at or below which p % of the constraint variable starting from the minimum value falls. FIG. 8 illustrates a curve w15 of the prediction model of the target variable, a curve w16 of the prediction model of the constraint variable, and a straight line w17 of the relative constraint threshold value.

Next, a constraint variable equal to or less than the relative constraint threshold value is searched for. In the case of FIG. 8, the constraint variable at the measurement point p1 is searched for. Then, the relative constraint threshold value is updated in consideration of the searched constraint variable. In updating the relative constraint threshold value, as described above, the p percentile value of the current constraint variable including the newly searched constraint variable is selected.

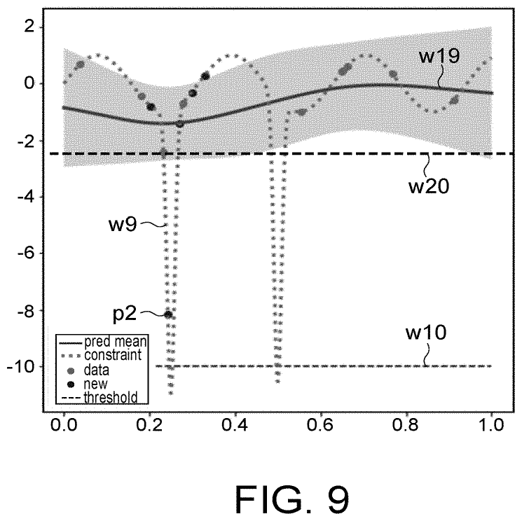

FIG. 9 is a diagram illustrating an intermediate state in which the relative constraint threshold value is updated. As illustrated, each time the relative constraint threshold value is updated, a new constraint variable is searched for. FIG. 9 illustrates a curve w19 of the prediction model of the constraint variable, and a straight line w20 of the relative constraint threshold value. As can be seen from a comparison between FIG. 8 and FIG. 9, the straight line w20 of the relative constraint threshold value is lower than the straight line w17 and approaches the absolute constraint threshold value w10. A decrease in the relative constraint threshold value indicates that the satisfaction of the constraint condition is stricter.

As described above, in the present embodiment, the provisional constraint threshold value or the relative constraint threshold value is gradually changed to make the constraint condition gradually strict. When the provisional constraint threshold value or the relative constraint threshold value is updated, a new constraint variable is searched for from the vicinity of the updated provisional constraint threshold value or the updated relative constraint threshold value. In the case of FIG. 9, the constraint variable at the measurement point p2 is newly searched for, and the relative constraint threshold value is updated including the constraint variable.

In this way, by repeatedly updating the provisional constraint threshold value or the relative constraint threshold value and searching for a new constraint variable, the provisional constraint threshold value or the relative constraint threshold value can be brought close to the absolute constraint threshold value. Note that the absolute constraint threshold value is a preset fixed value, and the provisional constraint threshold value or the relative constraint threshold value does not fall below the absolute constraint threshold value.

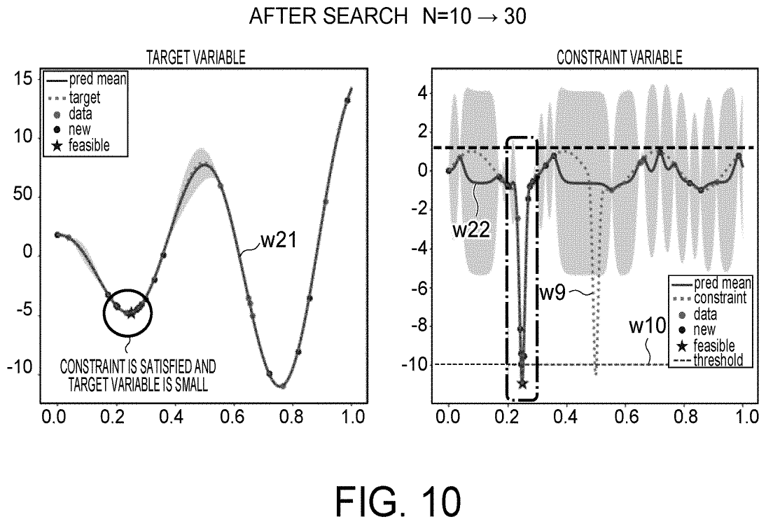

FIG. 10 is a diagram illustrating a final optimization result. FIG. 10 illustrates a curve w21 of the prediction model of the target variable, a curve w22 of the prediction model of the constraint variable, and a straight line w10 of the absolute constraint threshold value. The constraint threshold value existing near the absolute constraint threshold value can be accurately searched for. Therefore, the curve w22 of the prediction model of the constraint variable has a shape similar to the curve w9 of the actual constraint variable in FIG. 5.

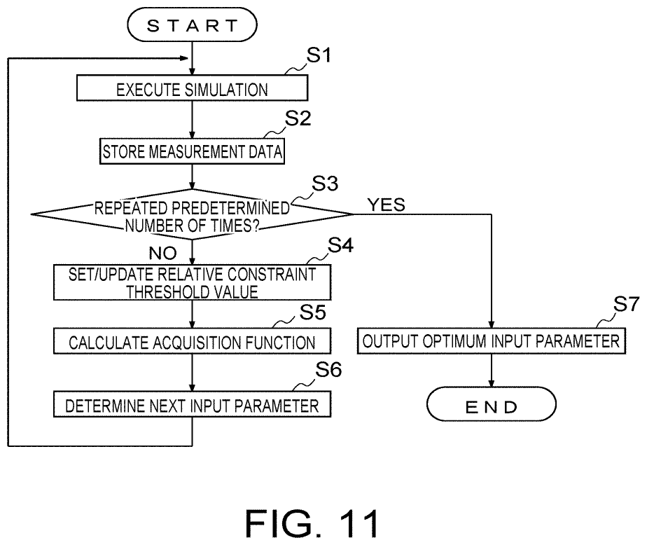

FIG. 11 is a flowchart illustrating a processing operation of the simulation system 2 according to the present embodiment. First, input parameters are input to the simulator 3, and the simulation is executed (step S1). In this step S1, the input parameters may be determined using a Latin square or a Sobol column.

Next, the output data acquisition unit 4 acquires measurement data indicating a simulation result of the simulator 3 to store the acquired measurement data in the input/output data storage unit 5 (step S2).

Next, it is determined whether the update of the above-described relative constraint threshold value and search for a new constraint variable have been repeated a predetermined number of times (step S3). In the present specification, the determination process in step S3 may be referred to as an iteration determination unit. When the predetermined number of times has not been reached yet, the relative constraint threshold value is set or updated (step S4). Here, for example, as described with reference to FIGS. 8 to 10, the relative constraint threshold value is regarded as, for example, a p percentile value of the constraint variable, and a constraint variable near the relative constraint threshold value is newly searched to perform the process of updating the relative constraint threshold value based on the newly searched constraint variable.

Next, the acquisition function calculation unit 7 calculates an acquisition function based on the input parameters and the relative constraint threshold value (step S5).

Equation (1) indicates an example of the acquisition function. In Equation (1), the p percentile value is regarded as a relative constraint threshold value, and the constraint variable equal to or less than the relative constraint threshold value is assumed to satisfy the constraint condition to calculate the acquisition function. This acquisition function is a value obtained by multiplying the expected improvement amount EI by the satisfiability of the constraint variable.

$${α}_{BO} ( x \vert {f}^{*} ) {\prod }_{j = 1}^{J} P ( {c}_{j} ( x ) \leq {t}_{j} ( x \vert D ) ) \qquad ( 1 )$$

tⱼ(x|D)=Percentile (D|p)D: measurement data, p:percentile value

Next, the next input parameter determination unit 8 determines the next input parameter so that the value of the acquisition function is maximum (step S6), and repeats the process of step S1 and subsequent steps. When it is determined in step S3 that the predetermined number of times has been reached, an input parameter in a case where the target variable is minimized is output as an optimal input parameter (step S7).

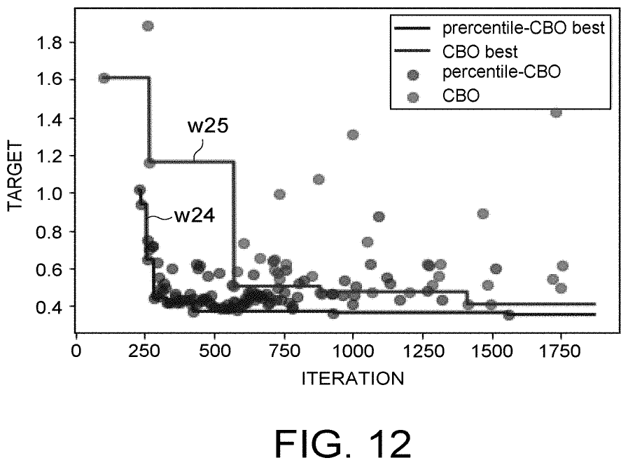

FIG. 12 is a diagram comparing the processing result of optimization according to the present embodiment with that of the Bayesian optimization of one comparative example. In FIG. 12, the horizontal axis represents the number of repetitions of processing until a constraint satisfaction solution is obtained, and the vertical axis represents the value of the target variable. This result indicates a result of solving the minimization problem, and indicates that the smaller the value of the target variable, the better the result. As can be seen by comparing a characteristic curve w24 of the present embodiment with a characteristic curve w25 of one comparative example, the optimization according to the present embodiment can reduce the value of the target variable with a smaller number of processing times than the Bayesian optimization, and the effectiveness of the optimization process according to the present embodiment is clear.

In this way, in the first embodiment, by repeating the process in which a relative constraint threshold value is set by a p percentile value of a constraint variable or the like, a new constraint variable is searched for from its neighborhood based on the set relative constraint threshold value, and the relative constraint threshold value is updated based on the searched new constraint variable, the relative constraint threshold value can be brought close to the absolute constraint threshold value to search for a constraint variable near the absolute constraint threshold value. Therefore, the input parameters input to the simulator 3 and the experimental device can be optimized based on the searched constraint variable.

According to the first embodiment, as illustrated in FIG. 5, even when the constraint variable changes locally and rapidly, it is possible to generate the prediction model of the constraint variable capable of faithfully reproducing the change.

### Second Embodiment

The information processing apparatus 1 and the simulation system 2 according to the second embodiment optimize input parameters so as to minimize the amount of data (FBC: Fail Bit Count) by which data cannot be correctly written in the semiconductor storage device.

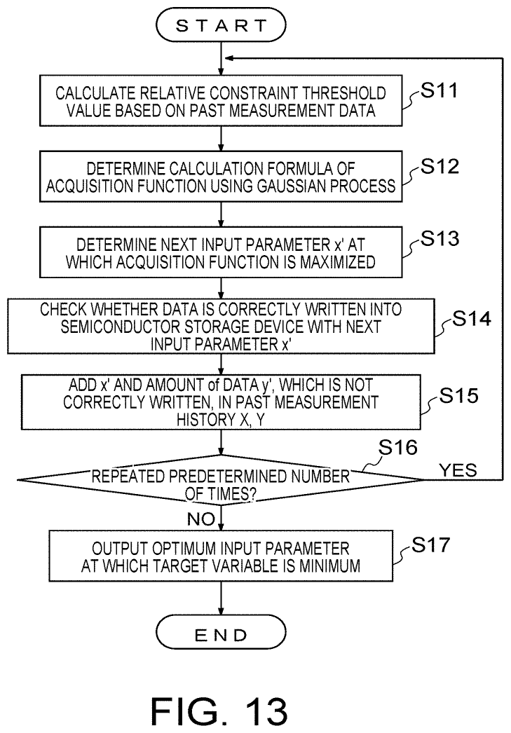

The information processing apparatus 1 and the simulation system 2 according to the second embodiment have a block configuration similar to that in FIG. 1. FIG. 13 is a flowchart illustrating a processing operation of the simulation system 2 according to the second embodiment.

A target variable l(x) and a constraint variable c(x) in the second embodiment are expressed by Equations (2) and (3), respectively.

l(x)=y₁(x) (2)

c(x)=y₂(x) (3)

y₁(x) is the amount of data that has not been correctly written in the semiconductor storage device. y₂(x) is the worst value of many other measured amounts.

First, a relative constraint threshold value is calculated based on past measurement data (step S11). The measurement data is y={y₁(x), y₂(x)}. Here, for example, the p percentile value of the past measurement data is regarded as the relative constraint threshold value. That is, a value at or below which p % of the past measurement data starting from the minimum value falls is regarded as the relative constraint threshold value.

Next, the calculation formula of the acquisition function is determined using the Gaussian process for each of the target variable l(x) and the constraint variable c(x) from the past measurement data (step S12). The calculation formula of the acquisition function is expressed by, for example, the above-described Equation (1), and is a value obtained by multiplying the expected improvement amount EI by the satisfiability of the constraint condition of the constraint variable c(x).

Next, the next input parameter x′ at which the acquisition function is maximized is determined based on the calculation formula determined in step S12 (step S13). Here, the input parameter is a control parameter related to the write operation to the semiconductor storage device, for example, a write pulse width, a write voltage, a standby time, a voltage rise (fall) pace, or the like.

Next, when data is written in the semiconductor device based on the next input parameter determined in step S13, it is checked whether the data is correctly written (step S14). Here, an amount of data y′ by which data cannot be correctly written is measured. Next, x′ and y′ are added in the history information X and Y of the past measurement data (step S15).

Next, it is determined whether the process of steps S11 to S15 has been repeated a predetermined number of times (step S16). When the predetermined number of times has not been reached yet, the process of step S11 and subsequent steps is repeated. When the predetermined number of times is reached, the optimum input parameter x is output (step S17). Here, the optimum input parameter is an input parameter x at which FBC, which is the target variable l(x), is minimized, and is expressed by the following Equation (4).

$${min}_{c ( x ) \leq λ} l ( x ) \qquad ( 4 )$$

As described above, according to the second embodiment, it is possible to determine the input parameter x that minimizes the amount of data by which data cannot be correctly written in the semiconductor storage device.

### Third Embodiment

In the first and second embodiments, the example in which the relative constraint threshold value is set based on the p percentile value of the constraint variable is described, but the value of p may be made variable. For example, the value of p may be initially made large and gradually decreased.

Alternatively, when the best (optimal) value of the constraint variable has not been updated for a predetermined period, the value of p may be made large, and when the best value is updated within the predetermined period, the value of p may be made small.

Alternatively, when the best value of the target variable has not been updated for a predetermined period, the value of p may be made larger, and when the best value is updated within the predetermined period, the value of p may be made small.

In this way, by varying the p percentile value, it is possible to search for the best value of each of the constraint variable and the target variable in a shorter time.

### Fourth Embodiment

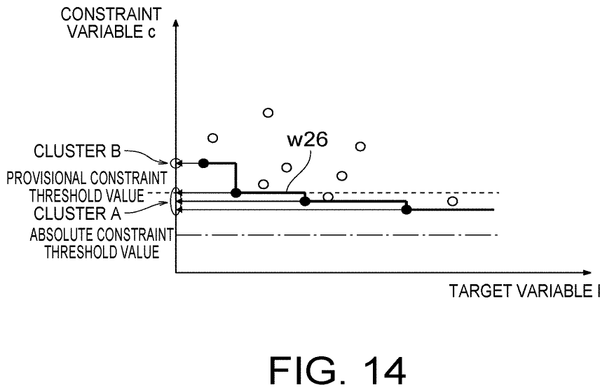

Both the target variable and the constraint variable are measurement result data and are associated with each other. FIG. 14 is a diagram illustrating a correspondence relationship between a target variable and a constraint variable by plotting. In FIG. 14, the horizontal axis represents the value of the target variable, and the vertical axis represents the value of the constraint variable. Both white plots and black plots show measurement result data. The black plots express that the measurement data having the target variable and the constraint variable smaller than those of the black plots is not present. The white plots express that the measurement data having the target variable and the constraint variable smaller than those of the white plots is present. In the case of solving the minimization problem, it is desirable that both the target variable and the constraint variable be small. However, it is difficult to make them smaller. A trade-off curve called as a pareto front w26 can be provided by using a plot group of the black plots in FIG. 14. With the pareto front w26, the plot group of the black plots on the vertical axis is classified into two or more clusters. The maximum value of the constraint variable of the cluster having the smaller value on the vertical axis may be used as the provisional constraint threshold value (relative constraint threshold value).

In the first to fourth embodiments described above, the example of optimizing the input parameters so as to obtain the minimum value of the target variable by solving the minimization problem is described. However, the input parameters may be optimized so as to obtain the maximum value of the target variable by solving the maximization problem.

At least part of the information processing apparatus 1 and the simulation system 2 described in each of the above-described embodiments may be configured by hardware or software. In a case where the information processing apparatus 1 and the simulation system 2 are configured by software, a program for realizing at least some functions of the information processing apparatus 1 and the simulation system 2 may be stored in a recording medium such as a flexible disk or a CD-ROM, and may be read and executed by a computer. The recording medium is not limited to a removable recording medium such as a magnetic disk or an optical disk, and may be a fixed recording medium such as a hard disk device or a memory.

In addition, a program for realizing at least some functions of the information processing apparatus 1 and the simulation system 2 may be distributed via a communication line (including radio communication) such as the Internet. Further, the program may be distributed via a wired line or a radio line such as the Internet or stored in a recording medium in an encrypted, modulated, or compressed state.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. An information processing apparatus comprising:
a constraint threshold value setting change unit configured to change a setting of a first constraint threshold value serving as a criterion when determining whether a constraint variable satisfies a constraint condition; and
a search unit configured to search for the new constraint variable that satisfies the constraint condition based on the first constraint threshold value, wherein
the constraint threshold value setting change unit is configured to update the first constraint threshold value based on the new constraint variable.

2. The information processing apparatus according to claim 1, wherein
a process of the constraint threshold value setting change unit and a process of the search unit are repeatedly performed until a predetermined end condition is satisfied.

3. The information processing apparatus according to claim 1, wherein
the search unit is configured to search for the new constraint variable that is located near the first constraint threshold value set by the constraint threshold value setting change unit and that satisfies the constraint condition.

4. The information processing apparatus according to claim 1, further comprising:
an output data acquisition unit configured to acquire an output value obtained by performing an experiment or a simulation based on input parameters of a predetermined number of dimensions;
an acquisition function calculation unit configured to calculate an acquisition function based on the input parameters and the first constraint threshold value; and
a next input parameter determination unit configured to determine a next input parameter used for an experiment or a simulation so that a value of the acquisition function is maximum.

5. The information processing apparatus according to claim 4, wherein
the input parameter is a parameter representing a physical quantity that affects the output value.

6. The information processing apparatus according to claim 1, wherein
measurement result data by an experiment or a simulation is a target variable, and
the constraint variable is constrained data associated with the target variable.

7. The information processing apparatus according to claim 6, wherein
the constraint variable includes a plurality of pieces of data, and
the constraint threshold value setting change unit is configured to set the first constraint threshold value from among the plurality of pieces of data disposed in ascending or descending order.

8. The information processing apparatus according to claim 7, wherein
the first constraint threshold value is a predetermined percentile value selected from among the plurality of pieces of data disposed in ascending or descending order.

9. The information processing apparatus according to claim 7, wherein
the first constraint threshold value is selected based on a plurality of statistical values corresponding to the plurality of pieces of data.

10. The information processing apparatus according to claim 1, wherein
the first constraint threshold value is a value that defines the constraint condition looser than a preset second constraint threshold value.

11. The information processing apparatus according to claim 10, wherein
as a process of the constraint threshold value setting change unit and a process of the search unit are repeated, the first constraint threshold value gradually approaches the second constraint threshold value.

12. The information processing apparatus according to claim 10, wherein
the first constraint threshold value is configured to change as a process of the constraint threshold value setting change unit and a process of the search unit are repeated, and
the second constraint threshold value is unchanged as a process of the constraint threshold value setting change unit and a process of the search unit are repeated.

13. The information processing apparatus according to claim 1, wherein
the constraint threshold value setting change unit is configured to change a criterion for updating the first constraint threshold value based on whether a best value of at least one of a target variable and the constraint variable is updated while updating the first constraint threshold value a predetermined number of times.

14. The information processing apparatus according to claim 13, wherein
the constraint threshold value setting change unit is configured to update the first constraint threshold value so that the constraint condition is stricter in a case where the best value of at least one of the target variable and the constraint variable is updated while updating the first constraint threshold value the predetermined number of times, and update the first constraint threshold value so that the constraint condition is relaxed in a case where none of the best value of the target variable and the best value of the constraint variable are updated while updating the first constraint threshold value the predetermined number of times.

15. The information processing apparatus according to claim 1, wherein
the constraint threshold value setting change unit is configured to update the first constraint threshold value based on a distribution of a target variable and the constraint variable associated with each other.

16. The information processing apparatus according to claim 2, wherein
the constraint threshold value setting change unit is configured to minimize or maximize the first constraint threshold value until the predetermined end condition is satisfied.

17. The information processing apparatus according to claim 4, wherein
the constraint threshold value setting change unit and the search unit are configured to optimize the input parameters so as to minimize an amount of data by which data cannot be correctly written in a semiconductor storage device.

18. An information processing method comprising:
changing a setting of a first constraint threshold value serving as a criterion when determining whether a constraint variable satisfies a constraint condition; and
searching for the new constraint variable that satisfies the constraint condition based on the first constraint threshold value, wherein
the first constraint threshold value is updated based on the new constraint variable.

19. The information processing method according to claim 18, wherein
the changing the setting of the first constraint threshold value and the searching for the new constraint variable are repeatedly performed until a predetermined end condition is satisfied.

20. The information processing method according to claim 18, wherein
the searching for the new constraint variable includes searching for the new constraint variable that is located near the first constraint threshold value and that satisfies the constraint condition.
